(19) United States
(12) Patent Application Publication
(10) Pub. No.: US 2026/0153795 A1
(43) Pub. Date: Jun. 4, 2026

(54) SHOOTING MECHANISM, UNMANNED AERIAL VEHICLE AND CONTROL METHOD THEREOF

(71) Applicant: Arashi Vision Inc., Shenzhen,Guangdong (CN)

(72) Inventors: Fanli PANG, Shenzhen,Guangdong (CN); Fei GAO, Shenzhen,Guangdong (CN)

(73) Assignee: Arashi Vision Inc., Shenzhen,Guangdong (CN)

(21) Appl. No.: 19/176,209

(22) Filed: Apr. 11, 2025

Related U.S. Application Data
(63) Continuation of application No. PCT/CN2023/099281, filed on Jun. 9, 2023.

(30) Foreign Application Priority Data
Jun. 10, 2022 (CN) 202221460765.X

(51) Int. Cl. G03B 37/02; B64U 20/70; B64U 20/87; B64U 101/30; G03B 15/00

(52) U.S. Cl. CPC G03B 37/02; B64U 20/70; B64U 20/87; G03B 15/006; B64U 2101/30

(57) ABSTRACT

A unmanned aerial vehicle (UAV) may comprise a fuselage body; a shooting structure comprising a rotating bracket and two lenses respectively arranged at two ends of the rotating bracket, wherein the rotating bracket is rotatably connected to the fuselage body; and a driver to drive the rotating bracket to rotate relative to the fuselage body so that the two lenses protrude from a top end and a bottom end of the fuselage body respectively.

### CROSS-REFERENCE TO RELATED APPLICATIONS

The present application is a continuation application of international patent application No. PCT/CN 2023/099281, filed on Jun. 9, 2023, which claims priority to Chinese Patent Application No. 202221460765.X, filed Jun. 10, 2022, the entire contents of both being incorporated herein by reference in its entirety.

### TECHNICAL OF FIELD

The present disclosure belongs to a technical field of unmanned aerial vehicles (UAV), and in particular, relates to a shooting mechanism, an unmanned aerial vehicle, and a control method of the UAV.

### BACKGROUND

In prior art, a panoramic lens of a UAV usually has modes of lifting up and retracting down. When retracting, a distance between a lower lens and the ground is very small, and a top end of a curved surface of the lens faces the ground, which is easily scratched and damaged by foreign objects protruding from the ground, thereby affecting the service life of the lens. Accordingly, the lens needs frequent maintenance.

### SUMMARY

The purpose of the present disclosure is to overcome deficiencies of the above-mentioned prior art or other problems and to provide a shooting mechanism, a UAV and a UAV control method, which can flexibly adjust a relative position of lenses and the fuselage body of the UAV by rotating the lenses, which is beneficial to lens protection.

In a first aspect, the present disclosure provides a UAV. The UAV may comprise a fuselage body; a shooting structure comprising a rotating bracket and two lenses respectively arranged at two ends of the rotating bracket, wherein the rotating bracket is rotatably connected to the fuselage body; and a driver to drive the rotating bracket to rotate relative to the fuselage body so that the two lenses protrude from a top end and a bottom end of the fuselage body respectively.

In a second aspect, the present disclosure provides a method for controlling a UAV. The UAV comprises a fuselage body, a shooting structure comprising a rotating bracket and two lenses respectively arranged at two ends of the rotating bracket, and a driver to drive the rotating bracket to rotate. The method may include receiving a shooting structure control instruction, wherein the shooting structure control instruction is configured to rotate the shooting structure relative to the fuselage body to a preset angle; obtaining status information of the driver; calculating posture information of the shooting structure according to the state information and the shooting structure control instruction; outputting one or more motor signals according to the posture information; according to the one or more motor signals, controlling the driver to adjust the shooting structure to the preset angle; and controlling the shooting structure to obtain image data for generating a panoramic image or a panoramic video.

In a third aspect, the present disclosure provides an UAV, comprising a fuselage body, the fuselage body including a head and a tail located opposite to each other in a direction of a roll axis; a shooting structure, including two lenses respectively arranged at both ends, the shooting structure being rotatably connected to a part of the fuselage body between the head and the tail so that the lenses at the two ends can protrude from the top end and the bottom end of the fuselage body, respectively.

The UAV and UAV control method provided by some embodiments of the present disclosure may have following characteristics: since the lenses are fixedly connected to the rotating bracket, the rotating bracket is driven to rotate by the arranged driver. When the UAV needs to shoot or flies to a certain height, the lenses can be driven to rotate by the driver so that the lenses protrude from the top end and the bottom end of the fuselage body so that the fuselage body does not block the shooting angle, which is conducive to panoramic shooting; when the UAV is preparing to take off or land, the lenses are driven to rotate by the driver so that the lenses do not protrude from the top and bottom ends of fuselage body, so that the lenses are protected to prevent the lenses from being bumped and damaged.

### BRIEF DESCRIPTION OF THE DRAWINGS

In order to more clearly illustrate the technical solutions in the embodiments of the present disclosure, the accompanying drawings to be used in the embodiments will be briefly introduced below, and it will be obvious that the accompanying drawings in the following description are only some of the embodiments of the present disclosure, and that for the person of ordinary skill in the field, other accompanying drawings can be obtained based on these drawings, without giving creative labor.

FIG. 1 is a schematic structural diagram of a rotating bracket rotating to a horizontal state in a UAV provided by an embodiment of the present disclosure;

FIG. 2 is a schematic structural diagram of a rotating bracket rotating to a horizontal state in a UAV provided by an embodiment of the present disclosure;

FIG. 3 is a schematic structural diagram of a rotating bracket rotating to a horizontal in a UAV provided by an embodiment of the present disclosure state ;

FIG. 4 is a schematic structural diagram of a rotating bracket rotating to a vertical state in a UAV provided by an embodiment of the present disclosure;

FIG. 5 is a schematic structural diagram of a rotating bracket rotating to a vertical state in a UAV provided by an embodiment of the present disclosure;

FIG. 6 is a perspective exploded view of a UAV provided by an embodiment of the present disclosure;

FIG. 7 is a schematic structural diagram of the rotating bracket rotating to another vertical state in a UAV provided by an embodiment of the present disclosure;

FIG. 8 is a schematic structural diagram of the rotating bracket rotating to another horizontal state in a UAV provided by an embodiment of the present disclosure;

FIG. 9 is a perspective exploded view of another UAV provided by an embodiment of the present disclosure;

FIG. 10 is a schematic structural diagram of a state of a shooting mechanism located inside a fuselage body of a UAV provided by an embodiment of the present disclosure;

FIG. 11 is a schematic structural diagram of another state of a shooting mechanism located inside the fuselage body of a UAV provided by an embodiment of the present disclosure;

FIG. 12 is a schematic diagram of distribution of optical axes of two lenses in a UAV provided by an embodiment of the present disclosure;

FIG. 13 is a schematic diagram of distribution of optical axes of two lenses in a UAV provided by an embodiment of the present disclosure;

FIG. 14 is a schematic diagram of distribution of optical axes of two lenses in a UAV provided by an embodiment of the present disclosure.

### NUMBERS IN THE FIGURES

1. 110—lens, 2. 120—lens fixing seat, 3. 130—rotating bracket, 31—connector, 32 triggering portion, 33—contact surface, 34—annular protrusion; 4—upper shell; 5—lower shell, 51—limiting portion; 6—coupling, 7—transmission assembly, 8. 140—driving assembly, 9 driving bracket, 10a—first switch, 10b—second switch, 100—rectangular parallelepiped, 103, 104—clamping section, 105—connecting portion.

### DETAILED DESCRIPTION

In order to make the purpose, technical solution and advantages of the present disclosure clearer, the present disclosure is further described in detail below in conjunction with the accompanying drawings and embodiments. It should be understood that the specific embodiments described herein are only used to explain the present disclosure and are not used to limit the present disclosure.

It should be noted that the terms “arranged” and “connected” should be understood in a broad sense. For example, it can be directly arranged on or connected to, or it can be indirectly arranged on or connected to through a central component or a central structure.

In addition, if there are terms such as “longitudinal”, “lateral”, “length”, “width”, “thickness”, “up”, “down”, “front”, “back”, “left”, “right”, “vertical”, “horizontal”, “top”, “bottom”, “inside”, “outside” and the like indicating orientation or positional relationship in the embodiments of the present disclosure, they are based on the orientation or positional relationship or the conventional placement state or usage state shown in the drawings, and are only for the convenience of describing the present disclosure and simplifying the description, and do not indicate or imply that the structure, feature, device or element referred to must have a specific orientation or positional relationship, nor must it be constructed and operated in a specific orientation, and therefore cannot be understood as a limitation on the present disclosure. In the description of the present disclosure, unless otherwise specified, “plurality” means two or more.

The various specific technical features and embodiments described in the specific implementation methods of the present disclosure can be combined in any suitable manner unless there is any contradiction. For example, different implementation methods can be formed by combining different specific technical features/embodiments of the present disclosure. In order to avoid unnecessary repetition, the various possible combinations of the specific technical features/embodiments in the present disclosure will not be described separately.

A UAV includes a fuselage body, a plurality of arms, and a plurality of power assemblies corresponding to the arms. The arms are connected to the fuselage body, and the power assemblies are arranged on the arms. The arms can be in an unfolded or folded state relative to the fuselage body. Optionally, when the UAV needs to fly, the arms are in an unfolded state relative to the fuselage body, in which state, the arms support the power assemblies at predetermined positions around the fuselage body; when the UAV is stored, the arms are in a folded state relative to the fuselage body, in which state, the arms together with the power assemblies can be folded around the fuselage body, so as to facilitate the storage and/or carrying and transportation of the UAV.

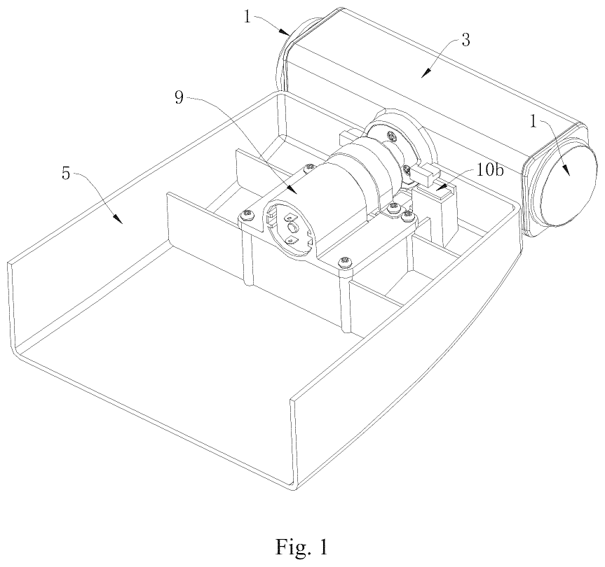

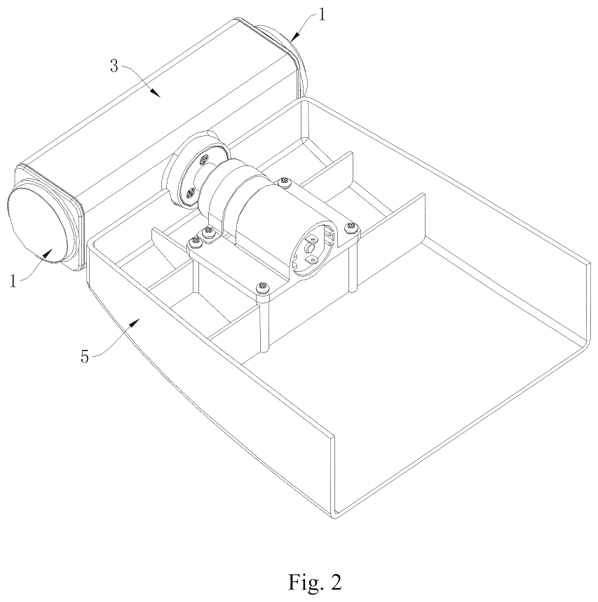

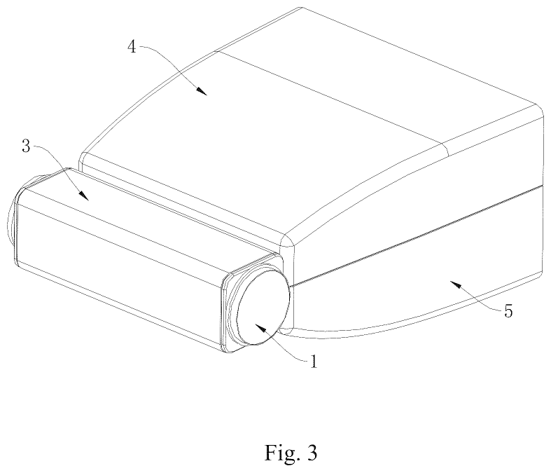

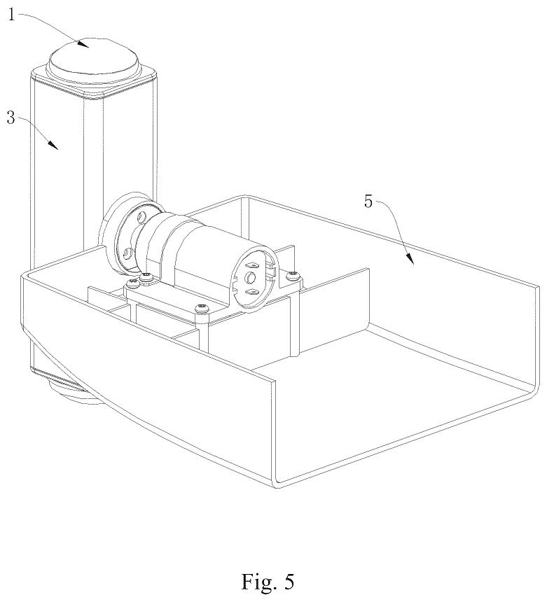

As shown in FIGS. 1 to 6, a UAV provided by an embodiment of the present disclosure includes a fuselage body, a shooting mechanism or structure and a driving mechanism or driver, wherein the shooting mechanism includes a rotating bracket 3 and a lens 1, wherein the lens 1 is fixedly connected to the rotating bracket 3, and the rotating bracket 3 is rotatably connected to the fuselage body; the driving mechanism is connected to the fuselage body, and the driving mechanism is used to drive the rotating bracket 3 to rotate so that the lens 1 protrudes from the fuselage. A UAV provided by an embodiment of the present disclosure, when the UAV needs to take images or flies to a certain height, the driving mechanism can drive the lens 1 to rotate so that the lens 1 protrudes from the fuselage body. As such, the fuselage body does not block the shooting angle, which is conducive to panoramic shooting; when the UAV is ready to take off or land, the driving mechanism drives the lens 1 to rotate so that the lens 1 does not protrude from the fuselage body, and the lens 1 is relatively far away from a bottom end of the fuselage body, which is conducive to protecting the lens 1 and preventing the lens 1 from being damaged by bumping.

In some embodiments, as shown in FIG. 1 to FIG. 5, the lens 1 is a panoramic lens, and the panoramic lenses are respectively arranged at both ends of the rotating bracket 3. When the rotating bracket 3 rotates to a vertical state, the lens 1 protrudes from the fuselage body, wherein one panoramic lens protrudes from a bottom end of the fuselage body, and the other panoramic lens protrudes from a top end of the fuselage body, and the fuselage body is located outside a field of view of the panoramic lenses; when the rotating bracket 3 rotates to a horizontal state, the lenses 1 are located between the bottom end and the top end of the fuselage body. In this embodiment, when the rotating bracket 3 rotates to a vertical state, that is, the axes of the two panoramic lenses are in a vertical state, so that the panoramic lenses are used for panoramic shooting and are not blocked by the fuselage body or other components; and during the descent process, when the panoramic lenses need to be protected, the rotating bracket 3 rotates to a horizontal state, that is, the axes of the two panoramic lenses are in a horizontal state, so that the panoramic lenses do not touch the ground, thereby preventing the panoramic lenses from being scratched.

In some embodiments, as shown in FIGS. 1 to 5, the two lenses 1 are symmetrically arranged relative to a rotation center of the rotating bracket 3, with high symmetry, more beautiful appearance, and easy installation; in other embodiments, the two lenses 1 are asymmetrically arranged relative to the rotation center of the rotating bracket 3, that is, the two lenses 1 are arranged at both ends of the rotating bracket 3, and the rotation center is located on one side of a geometrical center of the rotating bracket 3 (off-center arrangement). The two lenses 1 have different displacements when rotating, which can also prevent the lens contacting with the ground. According to the specific settings of the UAV (such as the setting positions of wings, blades, etc.), the rotation center can be flexibly adjusted to further avoid (or reduce) the shooting angle of the panoramic lens from being blocked by components such as wings and blades.

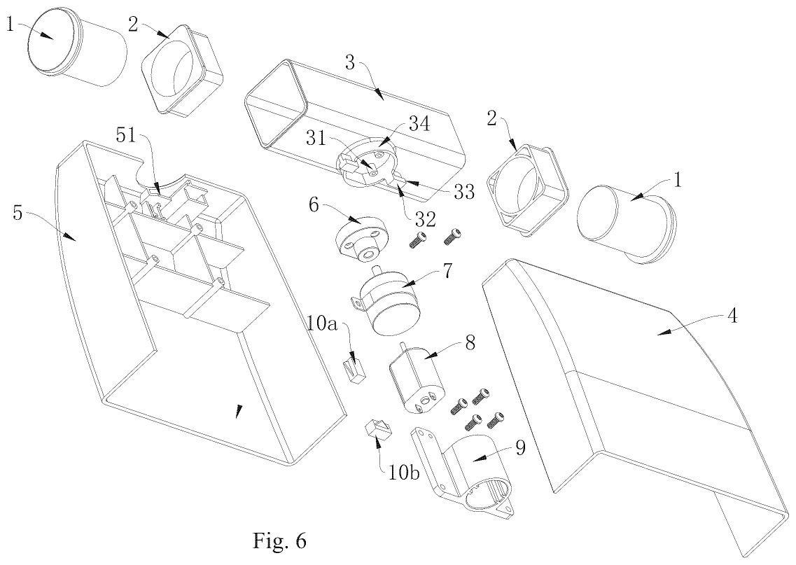

In some embodiments, as shown in FIG. 6, a UAV has a positioning assembly, and the positioning assembly is used to cause the shooting mechanism to stop rotation at a set position. The positioning assembly includes a control switch, and the control switch includes a first switch 10a and a second switch 10b. When the rotating bracket 3 rotates to a longitudinal direction of the fuselage body, that is, when the rotating bracket 3 rotates to a vertical state, a triggering portion or structure 32 triggers the first switch 10a; when the rotating bracket 3 rotates to a lateral direction of the fuselage body, that is, when the rotating bracket 3 rotates to a horizontal state, the triggering portion 32 triggers the second switch 10b; the positioning assembly also includes a triggering portion 32, and the triggering portion 32 is fixedly arranged on the rotating bracket 3, and the control switch is arranged on the fuselage body and can be triggered by the triggering portion 32, and the control switch is connected to the driving mechanism; in another embodiment, the driving mechanism includes a servo motor, and the positioning assembly includes a controller, and the controller is connected to the servo motor, and the number of rotations of the servo motor is controlled by the controller, thereby controlling the interruption of the servo motor power (interruption when the rotating bracket 3 is in a vertical state or interruption when the rotating bracket 3 is in a horizontal state). In this embodiment, the fuselage body includes an upper shell 4 and a lower shell 5, and the control switch is installed on the lower shell 5. In one embodiment, the first switch 10a is arranged in a length direction of the fuselage body. When the trigger portion 32 contacts the first switch 10a of the lower shell 5, the motor power is cut off, and the lenses 1 remain in a vertical position; the second switch 10b is arranged in a width direction of the fuselage body. When the trigger portion 32 contacts the second switch 10b of the lower shell 5, the motor power is cut off, and the lenses 1 remain in a horizontal position.

In some embodiments, as shown in FIG. 6, the fuselage body is provided with a limiting portion or structure 51, and the rotating bracket 3 has a contact surface 33. When the triggering portion 32 triggers the control switch, the limiting portion 51 contacts the contact surface 33. Specifically, the rotating bracket 3 is a sleeve, and the two lenses 1 are fixed at the two ends of the sleeve through lens fixing seats 2. The lower shell 5 is provided with the limiting portion, and the contact surface 33 is located at one end of the triggering portion 32. The rotating bracket 3 is provided with an annular protrusion 34 on a side facing the fuselage body, and the fuselage body has a connecting hole, and the annular protrusion 34 extends into the connecting hole; the triggering portion 32 is protrudingly arranged on the end face or outer side face of the annular protrusion 34; the triggering portion 32 includes two protrusions with a T-shaped cross-section, and the contact surface 33 is a side face of the triggering portion 32, which is reliably abutted and used to prevent an inertial movement of the rotating bracket 3 after the driving mechanism stops rotating, so as to ensure the reliable positioning of the rotating bracket 3 in a vertical state or a horizontal state. Moreover, even if the control switch fails, the mechanical limit formed by the limiting portion 51 and the contact surface 33 can also keep the lens 1 in a vertical state or a horizontal state.

In some embodiments, the rotating bracket 3 can be rotated to an inclined direction relative to the fuselage body so that the lenses 1 do not protrude from the fuselage body. In specific applications, the rotating bracket 3 can be tilted relative to the fuselage body by controlling the number of rotations of the servo motor. In this embodiment, the rotating axis of the rotating bracket 3 is in the same direction as a length direction of the fuselage body. In another embodiment, the rotating axis of the rotating bracket 3 can also be in the same direction as a width direction of the fuselage body, and the rotating bracket 3 can also be rotated to the inclined direction of the fuselage body, thereby ensuring that the lenses 1 do not touch the ground to protect the lenses 1.

In some embodiments, as shown in FIG. 6, the driving mechanism includes a driving assembly 8 and a transmission assembly 7, and the transmission assembly 7 is respectively connected to the driving assembly 8 and the shooting mechanism; the driving mechanism also includes a coupling 6, and the rotating bracket 3 has a connector 31 on the side facing the fuselage body, and the transmission assembly 7 has an output shaft and an input shaft, the input shaft is connected to the driving assembly 8, and the output shaft is connected to the coupling 6, and the coupling 6 is connected to the connector 31. In a specific application, the motor has a motor shaft, which is connected to the transmission assembly 7, and the transmission assembly 7 is connected to the shooting mechanism; the driving assembly 8 includes a motor, and the transmission assembly 7 is a transmission, specifically a reducer, the motor is connected to the reducer, and then installed in a driving bracket 9, and fixedly connected to the lower shell 5, one end of the reducer extends into the coupling 6, the annular protrusion 34 of the sleeve extends into the connecting hole, and the connector 31 (specifically the insertion shaft) located in the annular protrusion 34 extends into the coupling 6, and a reduction ratio of the planetary gear can be reasonably designed, so that the rotating bracket 3 can be rotated and have a self-locking effect. That is, when moving violently, the airflow will not change its rotation angle. In another embodiment, the transmission assembly 7 can also be a commutator.

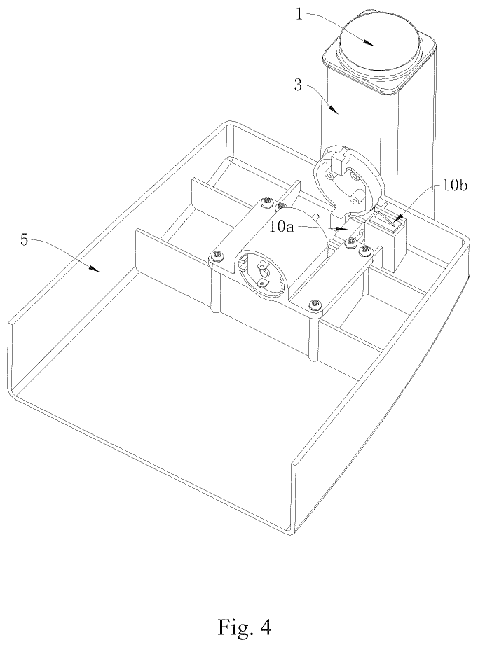

In some embodiments, as shown in FIG. 4, the UAV further includes a height detection mechanism or height detector. When the UAV descends to a preset height, the height detection mechanism is used to control the rotating bracket 3 to rotate to the lateral direction of the fuselage body. When the UAV approaches the ground during landing, the rotating bracket 3 is timely controlled to rotate through detection by the height detection mechanism, so that the lens 1 close to the bottom of the UAV can be rotated in a direction away from the bottom of the UAV to avoid scratches and damage to the lens 1.

In some embodiments, the UAV also includes a position detection control mechanism, which includes a detection module or structure and a control module or structure. The control module is electrically connected to the driving mechanism. The detection module is used to detect the position state of the shooting mechanism and input an electrical signal to the control module. The control module controls the driving mechanism to start or stop according to the electrical signal of the detection module.

In some embodiments, as shown in FIGS. 1-6, the shooting mechanism of the UAV is rotatably connected to the fuselage body, so that when the shooting mechanism rotates to a first preset angle relative to the fuselage body around a first rotation axis parallel to the roll axis, image data for generating a panoramic image or a panoramic video is obtained. The shooting mechanism in this embodiment can be rotatably mounted on the UAV fuselage body, and the shooting mechanism is used to shoot a panoramic image or a panoramic video. The driving mechanism is also provided in the UAV fuselage body or the shooting mechanism, and the driving mechanism can drive the shooting mechanism to a first preset angle around a first rotation axis parallel to the roll axis during the flight of the UAV or when a relevant shooting command is received. The shooting mechanism can obtain a shooting angle with less obstruction or even a complete shooting angle at the first preset angle, which is conducive to panoramic shooting.

In some embodiments, as shown in FIGS. 1-6, the shooting mechanism includes a rotating bracket 3 and lenses 1 respectively arranged at both ends of the bracket, and the driving mechanism is used to drive the rotating bracket 3 to rotate relative to the fuselage body around a first rotation axis parallel to the roll axis, i.e., the roll axis, to a first preset angle, so that the lenses protrude from the top and bottom of the fuselage body respectively, and the first preset angle includes 90°. It can be understood that the rotating bracket 3 on the shooting mechanism is rotatably connected to the driving mechanism, and the lenses 1 are respectively fixedly or detachably connected to the two ends of the rotating bracket 3, so that when the driving mechanism rotates around the first rotation axis parallel to the roll axis and drives the rotating bracket to rotate, the positions of the lenses 1 at both ends of the rotating bracket relative to the UAV fuselage body are correspondingly changed. When the rotating bracket rotates to the first preset angle, the lenses at both ends of the rotating bracket can protrude from the top and bottom of the UAV fuselage body, thereby ensuring integrity of the shooting angle. Furthermore, there may be multiple first preset angles. For example, the rotating bracket can be rotated to a vertical or inclined position relative to the fuselage body. At this time, by rotating 30°, 45°, 60°, or 90° and other preset angles, the lenses at both ends of the rotating bracket can protrude from the top and bottom of the main body.

In some embodiments, the lens includes a lens with a field of view of more than 180°, and the optical axes of the two lenses coincide. When the rotating bracket is rotated to be parallel to the heading axis, the lens protrudes from the top end and the bottom end of the fuselage body respectively; when the rotating bracket is rotated to be parallel to the roll axis, the lens is located between the top end and the bottom end of the fuselage body. In order to achieve panoramic shooting, in this embodiment, a lens is set at each end of the rotating bracket, and a wide-angle lens, especially a lens with a field of view of more than 180°, is used, and the optical axes of the lenses coincide, so that the purpose of panoramic shooting can be achieved. For example, two wide-angle lenses each with a field of view of more than 180° can be used to obtain a complete panoramic viewing angle. When panoramic shooting is required, when the rotating bracket is rotated to be parallel to the heading axis, the lenses at both ends of the rotating bracket protrude from the top end and the bottom end of the fuselage body; when panoramic shooting is not required, when the rotating bracket is rotated to be parallel to the roll axis, the lens is located between the top end and the bottom end of the fuselage body, which protects the lenses and avoids lenses damage.

In some embodiments, as shown in FIGS. 1-6, the driving mechanism includes a motor, the motor includes a stator assembly and a positioning assembly, the positioning assembly is used to stop the shooting mechanism from rotating at a set position, the stator assembly is fixedly connected to the rotating bracket, or the positioning assembly is fixedly connected to the fuselage body. The motor in the driving mechanism is used to drive the shooting mechanism to rotate, and in order to stop the shooting mechanism at a preset position, a positioning assembly is also provided in the driving mechanism, and the positioning assembly can be a locking structure such as a convex block or a buckle. When the driving mechanism drives the shooting mechanism to a preset position, the positioning assembly can stop the rotation of the driving mechanism, thereby controlling the stop position of the shooting mechanism.

In some embodiments, a positioning component is provided in the UAV to stop the rotation of the shooting mechanism at a set position.

In some embodiments, the UAV includes a fuselage body and arms, the fuselage body includes a head located at one end in the roll axis direction of the UAV and a tail located at the other end in the roll axis direction, the head of the fuselage or close to the head is connected to at least one pair of arms, and the tail of the fuselage or close to the tail is connected to at least one pair of arms, and the shooting mechanism is rotatably connected to the head or tail of the fuselage body.

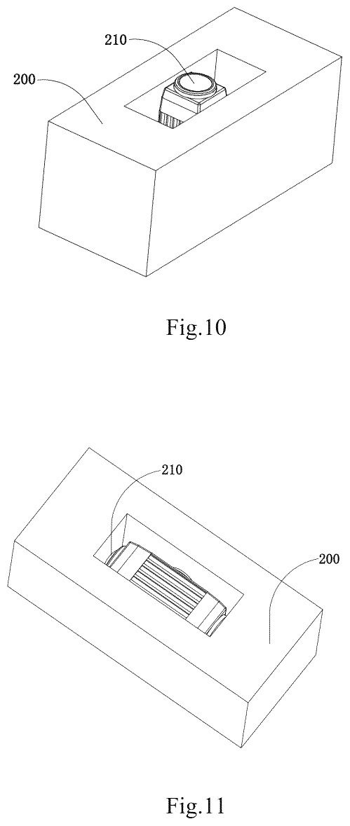

In some embodiments, the fuselage body of the UAV includes a head at one end of the roll axis direction and a tail at the other end of the roll axis, and the shooting mechanism is rotatably connected to the fuselage body between the head and the tail. As shown in FIGS. 10 and 11, the shooting mechanism is arranged inside the fuselage body. In some states, the lenses 210 at both ends of the shooting mechanism protrude from the top end and the bottom end of the fuselage body 200 to shoot a panoramic video with a spherical field of view; in other states, the shooting mechanism rotates so that the lenses 210 at both ends are located inside the fuselage body 200 to protect the lenses. It can be understood that the shooting mechanism can be arranged inside the fuselage body between the head and the tail, or on the side of the fuselage body between the head and the tail. The shooting mechanism is driven to rotate by the driving mechanism, and the lenses at both ends of the shooting mechanism can protrude from the fuselage body to enter a shooting state, or the lenses at both ends of the shooting mechanism are not protruded from the fuselage body and enter a protection state. In addition, the field of view of the lens may exceed 180°, so that when the lens protrudes from the fuselage body to enter a shooting state, the field of view of the two lenses can form a spherical field of view to shoot a panoramic image.

The rotation axis of the shooting mechanism can be the roll axis, the pitch axis or the yaw axis of the UAV. It is understandable that the shooting mechanism rotates around the rotation axis, and the lenses located at both ends of the shooting mechanism can shoot panoramic videos with spherical videos when shooting. For example, when the shooting mechanism is required to shoot, the UAV rotates the shooting mechanism so that the lenses at both ends can protrude from the top and bottom ends of the fuselage body, or protrude from the two sides of the fuselage body, respectively. At this time, the field of views of the two lenses can be spliced to form a spherical field of view.

In some embodiments, the shooting mechanism is rotatably connected to the fuselage body between the head and the tail, and can operate at multiple rotation angles. It is understandable that the rotating bracket in the shooting mechanism can rotate at preset angles such as 30°, 45°, 60°, or 90°. Even if the shooting mechanism has multiple tilt angles relative to the yaw axis of the UAV, the effect of the lens protruding from the top and bottom ends of the fuselage body can be achieved, and the shooting mechanism can perform the shooting task at the preset angle.

In some embodiments, a method for controlling a UAV includes: receiving a shooting mechanism control instruction, wherein the shooting mechanism control instruction is configured to rotate the shooting mechanism relative to the fuselage body to a first preset angle around a first rotation axis parallel to the roll axis of the UAV; obtaining status information of a driving mechanism; calculating posture information of the shooting mechanism based on the status information and the shooting mechanism control instruction; outputting one or more motor signals based on the posture information; controlling the driving mechanism to adjust the shooting mechanism to a first preset angle based on the one or more motor signals; and controlling the shooting mechanism to obtain image data for generating a panoramic image or a panoramic video.

In some embodiments, the method for controlling a UAV also includes receiving flight operation information, where the flight operation information is configured to instruct the flight of the UAV; and controlling the flight of the UAV according to the flight operation information.

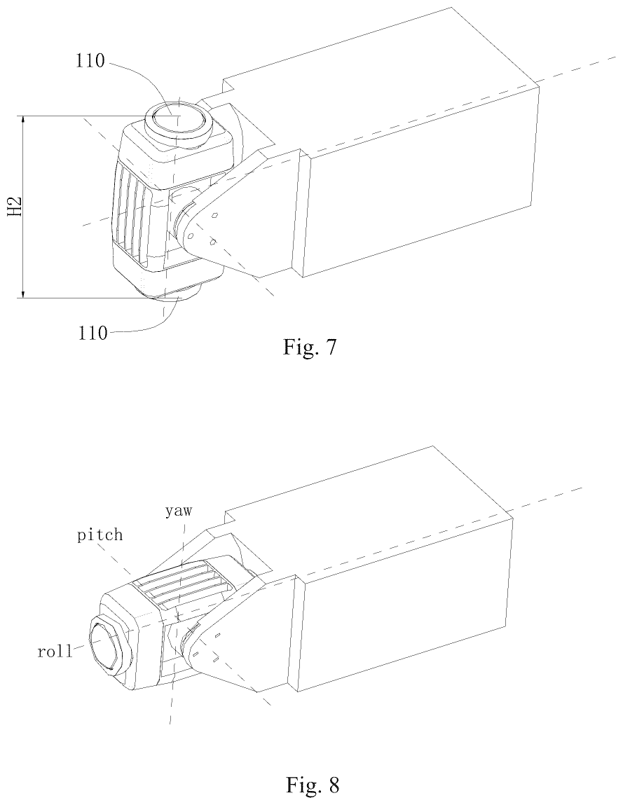

Furthermore, the fuselage body is a main accommodating structure and a supporting structure of the UAV. Sensors (e.g., inertial sensors, temperature sensors, altitude sensors, etc.), flight control modules, power supplies, etc. may be arranged inside or on the surface of the fuselage body, and the arms and the power components, etc. may be arranged outside the fuselage body. In this embodiment, the accommodating structure of the fuselage body is roughly in a shape of a rectangular parallelepiped, the rectangular parallelepiped 100 includes a head or tail at one end in the direction of the roll axis, the outer part of the rectangular parallelepiped 100 includes an upper shell 4 and a lower shell 5, and the supporting structure of the fuselage body includes an axially open groove arranged at the head or tail. In this embodiment, the highest point of the upper shell 4 is the top end of the fuselage body, and the lowest point of the lower shell 5 is the bottom end of the fuselage body. As shown in FIGS. 7-9, in this embodiment, the distance between the first end face where the top end is located and the second end face where the bottom end is located is H1. In order not to block the shooting field of view (FOV), the height of the shooting mechanism H2>H1, and the first end face and the second end face are parallel to the plane formed by the roll axis and the pitch axis.

In one embodiment, the shooting mechanism includes a rotating bracket and lenses respectively arranged at both ends of the bracket, the rotating bracket is used to be detachably mounted on the groove, and the driving mechanism is used to drive the rotating bracket to rotate relative to the fuselage body around a second rotation axis parallel to the pitch axis to an angle so that the lens protrudes from the top and bottom ends of the fuselage body, and the second preset angle includes 90°.

At the same time, the groove includes at least two clamping sections 103 and 104 arranged opposite to each other, the two clamping sections form a U-shaped cross section, and form a receiving cavity for accommodating the shooting mechanism. The groove also includes at least one connecting portion 105 formed on the clamping section 104. The rotating bracket of the shooting mechanism is connected to the groove through the connecting portion 105, and reciprocates around a rotation axis parallel to the pitch axis relative to the fuselage body at a certain angle (such as 90° to 180°) to obtain image data for generating panoramic images or panoramic videos. In order to improve the stability and reliability of the structure, the cross section of the clamping section is in the shape of an arc, and a central angle of the radial opening of the clamping section is less than 180°. In addition, the cross section of the clamping section can also be in any other applicable shape, such as an ellipse, which is not listed here.

Furthermore, in order to improve stability of the fixation between the shooting mechanism and the groove, the portion of the groove formed on the clamping portion 104 constitutes a pivotal portion, and the pivotal portion cooperates with the connecting portion 105 to further stabilize the shooting mechanism to prevent the shooting mechanism from shaking during the flight of the UAV.

In some embodiments, as shown in FIGS. 7-9, the UAV includes a fuselage body, a driving mechanism for driving a shooting mechanism to rotate, and the shooting mechanism is rotatably connected to the fuselage body, so that when the shooting mechanism rotates to a second preset angle relative to the fuselage body around a second rotation axis parallel to the pitch axis, image data for generating a panoramic image or a panoramic video is obtained. It is understandable that the shooting mechanism can also rotate relative to the fuselage body along the second rotation axis parallel to the pitch axis, so that the shooting mechanism can also achieve the effect of less obstruction or even a complete shooting angle at the second preset angle, which is conducive to panoramic shooting.

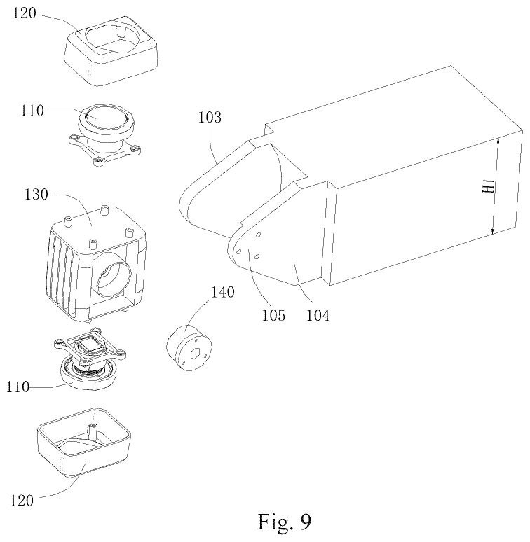

In some embodiments, as shown in FIG. 9, the roll axis direction of the fuselage body of the UAV is provided with an axially open groove, the shooting mechanism includes a rotating bracket 130 and lenses 110 respectively arranged at both ends of the bracket, the rotating bracket is used to be detachably mounted to the groove, and the driving mechanism is used to drive the rotating bracket to rotate relative to the fuselage body around a second rotation axis parallel to the pitch axis to a second preset angle, so that the lens protrudes from the top and bottom ends of the fuselage body, and the second preset angle includes 90°. It can be understood that the rotating bracket on the shooting mechanism is rotatably connected to the driving mechanism, and the lenses are fixedly or detachably connected to the two ends of the rotating bracket, so that when the driving mechanism rotates around the second rotation axis parallel to the pitch axis and drives the rotating bracket to rotate, the positions of the lenses at both ends of the rotating bracket relative to the fuselage body of the UAV are correspondingly changed. When the rotating bracket rotates to the second preset angle, the lenses at both ends of the rotating bracket can protrude from the top and bottom ends of the fuselage body of the UAV, thereby ensuring the integrity of the shooting angle. Furthermore, there may be multiple second preset angles. For example, the rotating bracket can be rotated to a vertical or inclined position relative to the fuselage body of the fuselage. At this time, by rotating 30°, 45°, 60°, or 90° and other preset angles, the lenses at both ends of the rotating bracket can protrude from the top and bottom ends of the fuselage body.

In some embodiments, the groove includes clamping sections 103 and 104, which rotatably connect the shooting mechanism to the groove on the fuselage body of the UAV, wherein a cross-section of the clamping section in a plane formed by the roll axis and the yaw axis is arc-shaped, and a central angle of the radial opening of the clamping section is less than 180°.

In some embodiments, the lens includes a lens with a field of view of more than 180°, the optical axes of the two lenses coincide, and when the rotating bracket is rotated to be parallel to the heading or yaw axis of fuselage body, the lens protrudes from the top and bottom ends of the body; when the rotating bracket is rotated to be parallel to the roll axis of the fuselage body, the lens is located between the top and bottom ends of the fuselage body.

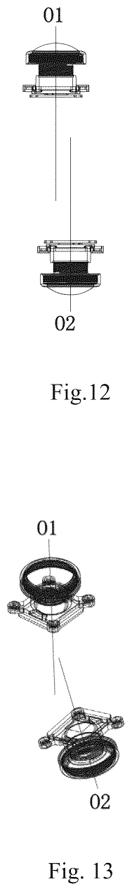

In some embodiments, two lenses capable of forming a spherical field of view are laterally offset from each other so that the two optical axes of the two lenses are separated by a certain distance laterally and do not intersect. The two optical axes may not intersect each other when the two lenses are in opposite directions but parallel to each other, as shown in FIG. 12, where the optical axes O1 and O2 of the two lenses are arranged in parallel. In some embodiment, the two optical axes may not intersect each other when the two lenses are in different directions but skew with each other, as shown in FIG. 13, where the optical axes O1 and O2 of the two lenses are skewed and do not intersect. By designing the optical axes of the two lenses to not intersect, the positions of the image sensors in the lenses can be staggered when compared with a design in which the two optical axes overlap without offset, thereby reducing the length of the entire lens assembly in the direction of the optical axis. The design in which the optical axes do not intersect can reduce the parallax effect between the two lenses to a certain extent.

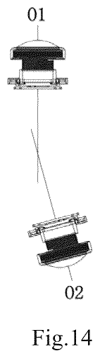

In some embodiments, the two optical axes intersect with each other, as shown in FIG. 14, the optical axes O1 and O2 of the two lenses intersect. For example, the angle between the two optical axes may be between 180° and 170°, or between 170° and 160°. Since the field of view angles of the two lenses are both greater than 180°, the two optical axes may have a certain angle without affecting the generation of the spherical field of view. By adjusting the angle between the optical axes, when compared with a design in which the two optical axes overlap or are parallel, the image captured in the tilt direction of the lens can be enhanced. For example, the optical axis of one lens of the shooting mechanism is directed toward the top of the fuselage along the heading axis, while the optical axis of the other lens intersects with the optical axis and is tilted at a certain angle toward the head direction of the fuselage, so that there is a certain angle between the two optical axes. At this time, the viewing angles of the two lenses have a more overlapping area in the head direction of the fuselage, and the more overlapping area is beneficial to the splicing effect between the two lenses.

In some embodiments, the two optical axes intersect with each other, as shown in FIG. 14, the optical axes O1 and O2 of the two lenses intersect. For example, the angle between the two optical axes may be between 180° and 170°, or between 170° and 160°. Since the field of views of the two lenses are both greater than 180°, the two optical axes may have a certain angle without affecting the generation of the spherical field of view. By adjusting the angle between the optical axes, the image captured in a tilted direction of the lens can be enhanced when compared with a design in which the two optical axes overlap or are parallel. For example, the optical axis of one lens of the shooting mechanism is directed toward the top of the fuselage along the yaw axis, while the optical axis of the other lens intersects with the optical axis and tilts toward the head of the fuselage body at a certain angle, so that there is a certain angle between the two optical axes. At this time, the field of views of the two lenses have a more overlapping area in the head direction of the fuselage body, and the more overlapping area is beneficial to the stitching effect between the two lenses.

In some embodiments, the driving mechanism includes a motor, the motor includes a stator assembly and a positioning assembly, the positioning assembly is used to stop the shooting mechanism from rotating at a set position, the stator assembly is fixedly connected to the rotating bracket, or the stator assembly is fixedly connected to the fuselage body.

In some embodiments, the UAV includes a fuselage body, the fuselage body includes a head located at one end of the roll axis direction of the UAV and a tail located at the other end of the roll axis direction, the UAV includes at least one pair of arms connected to the head of the fuselage or close to the head, and at least one pair of arms connected to the tail of the fuselage or close to the tail; the shooting mechanism is rotatably connected to the head or tail of the fuselage body.

In some embodiments, the UAV includes a fuselage body and arms, the fuselage body includes a head located at one end in the roll axis direction of the UAV and a tail located at the other end in the roll axis direction, the head of the fuselage or close to the head is connected to at least one pair of arms, and the tail of the fuselage or close to the tail is connected to at least one pair of arms; the shooting mechanism is rotatably connected to the head or tail of the fuselage body.

In some embodiments, the UAV includes a fuselage body and a shooting mechanism, wherein the shooting mechanism is rotatably connected to the head or tail of the fuselage body through a driving mechanism, and receives a shooting mechanism control instruction, wherein the shooting mechanism control instruction is configured to rotate the shooting mechanism relative to the fuselage body around a second rotation axis parallel to the roll axis to a second preset angle; obtain status information of the driving mechanism; calculate posture information of the shooting mechanism based on the status information and the shooting mechanism control instruction; output one or more motor signals based on the posture information; control the driving mechanism to adjust the shooting mechanism to the second preset angle based on the one or more motor signals; and control the shooting mechanism to obtain image data for generating a panoramic image or a panoramic video.

In some embodiments, the method for controlling a UAV further includes: receiving flight operation information, wherein the flight operation information is configured to instruct flight of the UAV; and controlling the flight of the UAV according to the flight operation information.

The shooting mechanism, the UAV and the control method of the UAV provided by some embodiments of the present disclosure are as follows: since the lenses 1 are fixedly connected to the rotating bracket 3, the rotating bracket 3 is driven to rotate by the arranged driving mechanism, and the relative position of the lenses 1 and the fuselage body is flexibly adjusted. When the UAV needs to shoot or flies to a certain height, the lenses 1 can be driven to rotate by the driving mechanism so that the lenses 1 protrude from the fuselage body so that the fuselage body does not block the shooting angle, which is conducive to panoramic shooting; when the UAV is ready to take off or land, the lenses 1 are driven to rotate by the driving mechanism so that the lenses 1 do not protrude from the fuselage body, so that the lenses 1 are protected to prevent them from being damaged by bumps.

The above-described embodiments only express several implementation of the present application, and the descriptions thereof are relatively specific and detailed, but they cannot be understood as limiting the scope of the present application. It should be pointed out that, for a person of ordinary skill in the art, several variations and improvements can be made without departing from the concept of the present application, and these all belong to the protection scope of the present application. Therefore, the protection scope of the present application shall be subject to the attached claims.

What is claimed is:

1. A unmanned aerial vehicle (UAV), comprising:
a fuselage body;
a shooting structure comprising a rotating bracket and two lenses respectively arranged at two ends of the rotating bracket, wherein the rotating bracket is rotatably connected to the fuselage body; and
a driver to drive the rotating bracket to rotate relative to the fuselage body to change positions of the two lenses relative to the fuselage body.

2. The UAV according to claim 1, wherein each of the two lenses is a panoramic lens, and in a case that the rotating bracket is rotated to a vertical state, the two lenses protrude from the top end and the bottom end of the fuselage body respectively; and in a case that the rotating bracket is rotated to a horizontal state, the two lenses are located between the bottom end and the top end of the fuselage body.

3. The UAV according to claim 2, wherein the two lenses are symmetrically arranged relative to a rotation center of the rotating bracket, or the two lenses are asymmetrically arranged relative to the rotation center of the rotating bracket.

4. The UAV according to claim 1, wherein the UAV comprises a positioning assembly configured to stop the shooting structure from rotation at a set position.

5. The UAV according to claim 4, wherein the positioning assembly includes a control switch and a triggering portion, the triggering portion is fixedly arranged on the rotating bracket, the control switch is arranged on the fuselage body and connected to the driver;
the control switch includes a first switch and a second switch, in a case that the rotating bracket rotates to be parallel to a heading axis of the fuselage body, the triggering portion triggers the first switch; and in a case that the rotating bracket rotates to be parallel to a pitch axis of the fuselage body, the triggering portion triggers the second switch.

6. The UAV according to claim 5, wherein the fuselage body is provided with a limiting portion, the rotating bracket comprises a contact surface which is a side surface of the trigger portion, and in a case that the triggering portion triggers the control switch, the limiting portion contacts the contact surface.

7. The UAV according to claim 1, wherein the driver is configured to rotate the rotating bracket to an inclined direction relative to the fuselage body so that the two lenses do not protrude from the top end and the bottom end of the fuselage body respectively.

8. The UAV according to claim 2, wherein the driver includes a driving assembly and a transmission assembly, and the transmission assembly is respectively connected to the driving assembly and the shooting structure;
the driver further includes a coupling, the rotating bracket has a connecting portion on a side facing the fuselage body, the transmission assembly has an output shaft and an input shaft, the input shaft is connected to the driving assembly, the output shaft is connected to the coupling, and the coupling is connected to the connecting portion.

9. The UAV according to claim 8, wherein the UAV further comprises a height detector, and in a case that the UAV descends to a preset height, the height detector is configured to control the rotating bracket to rotate to the horizontal state.

10. The UAV according to claim 8, wherein the UAV further includes a detection structure and a control structure, the control structure is electrically connected to the driver, the detection structure is configured to detect a position state of the shooting structure and input an electrical signal to the control structure, and the control structure controls the driver to start or stop according to the electrical signal of the detector.

11. The UAV according to claim 1, wherein the fuselage body comprises a head located at one end of a roll axis direction of the fuselage body and a tail located at the other end of the roll axis direction of the fuselage body; and the shooting structure is rotatably connected to the head or the tail of the fuselage body.

12. The UAV according to claim 1, wherein the driver is configured to drive the rotating bracket to rotate relative to the fuselage body around a first rotation axis parallel to a roll axis of the fuselage body to a first preset angle, so that the two lenses protrude from a top end and a bottom end of the fuselage body respectively.

13. The UAV according to claim 12, wherein each of the two lenses has a field of view of more than 180°, optical axes of the two lenses coincide, and in a case that the rotating bracket is rotated to be parallel to a heading axis of the fuselage body, the two lenses protrudes from the top end and the bottom end of the fuselage body respectively; and in a case that the rotating bracket is rotated to be parallel to a pitch axis of the fuselage body, the two lenses are located between the top end and bottom the end of the fuselage body.

14. The UAV according to claim 1, wherein optical axes of the two lenses are parallel to each other.

15. The UAV according to claim 1, wherein optical axes of the two lenses intersect with each other.

16. The UAV according to claim 1, wherein the fuselage body comprises a head at one end of a roll axis direction of the UAV and a tail at another end of the roll axis direction of the UAV, and the shooting structure is rotatably connected to a part of the fuselage body between the head and the tail.

17. The UAV according to claim 1, wherein the driver is configured to drive the rotating bracket to rotate relative to the fuselage body around a second rotation axis parallel to a pitch axis of the fuselage body to a second preset angle, so that the two lenses protrude from a top end and a bottom end of the fuselage body respectively.

18. The UAV according to claim 17, wherein a groove open along an axial direction is provided on a roll axis direction of the fuselage body, and the rotating bracket is detachably mounted in the groove.

19. The UAV according to claim 18, wherein the groove comprises a clamping section, and the shooting structure is rotatably connected to the clamping section, wherein a cross section of the clamping section in a plane parallel to the roll axis and a heading axis of the fuselage body is arc-shaped, and a central angle of a radial opening of the clamping section is less than 180°.

20. The UAV according to claim 19, wherein each of the two lenses has a field of view of more than 180°, optical axes of the two lenses coincide, and when the rotating bracket is rotated to be parallel to the heading axis, the two lenses protrude from the top end and the bottom end of the fuselage body respectively; and in a case that the rotating bracket is rotated to be parallel to the roll axis of fuselage body, the two lenses are located between the top end and the bottom end of the fuselage body.

21. A method for controlling a UAV, the UAV comprising a fuselage body, a shooting structure comprising a rotating bracket and two lenses respectively arranged at two ends of the rotating bracket, and a driver to drive the rotating bracket to rotate, the method comprising:
receiving a shooting structure control instruction, wherein the shooting structure control instruction is configured to rotate the shooting structure relative to the fuselage body to a preset angle;
obtaining status information of the driver;
calculating posture information of the shooting structure according to the state information and the shooting structure control instruction;
outputting one or more motor signals according to the posture information;
according to the one or more motor signals, controlling the driver to adjust the shooting structure to the preset angle; and
controlling the shooting structure to obtain image data for generating a panoramic image or a panoramic video.

22. The control method according to claim 21, wherein the driver is configured to rotate the shooting structure relative to the fuselage body around a first rotation axis parallel to a rolling axis of the fuselage body to a first preset angle, or
the driver is configured to rotate the shooting structure relative to the fuselage body around a second rotation axis parallel to a pitch axis of the fuselage body to a second preset angle.

23. The control method according to claim 21, further comprising:
receiving flight operation information, wherein the flight operation information is configured to instruct flight of the UAV; and
controlling the UAV to fly according to the flight operation information.

24. An unmanned aerial vehicle (UAV), comprising:
a fuselage body comprising a head and a tail opposite each other in a roll axis direction of the UAV; and
a shooting structure comprising two lenses respectively arranged at two ends of the shooting structure,
wherein the shooting structure is rotatably connected to a part of the fuselage body between the head and the tail so as to enable the two lenses at the two ends to protrude from a top end and a bottom end of the fuselage body respectively.

25. The UAV according to claim 24, wherein the shooting structure is rotatably connected to an internal part of the fuselage body between the head and the tail.

26. The UAV according to claim 24, wherein the shooting structure is rotatably connected to a side of the fuselage body between the head and the tail.

27. The UAV according to claim 24, wherein a field of view of each of the two lenses exceeds 180°.

28. The UAV according to claim 27, wherein when the two lenses at the both ends protrude from the top end and the bottom end of the fuselage body respectively, and a field of view of the two lenses forms a spherical field of view.

29. The UAV according to claim 24, wherein optical axes of the two lenses do not intersect with each other.

30. The UAV according to claim 24, wherein optical axes of the two lenses intersect with each other.
